(19) United States
(12) Patent Application Publication
(10) Pub. No.: US 2019/0318469 A1
(43) Pub. Date: Oct. 17, 2019

(54) DEFECT DETECTION USING COHERENT LIGHT ILLUMINATION AND ARTIFICIAL NEURAL NETWORK ANALYSIS OF SPECKLE PATTERNS

(71) Applicant: Coherent AI LLC, Madison, WI (US)

(72) Inventor: Xingze WANG, Durham, NC (US)

(73) Assignee: Coherent AI LLC, Madison, WI (US)

(21) Appl. No.: 16/101,384

(22) Filed: Aug. 10, 2018

Related U.S. Application Data
(60) Provisional application No. 62/658,843, filed on Apr. 17, 2018.

(51) Int. Cl. G06T 7/00; G06N 3/08; G06N 3/04; G02B 21/00; G02B 27/48

(52) U.S. Cl. CPC G06T 7/0004; G06N 3/08; G02B 27/48; G02B 21/0032; G06N 3/0472

(57) ABSTRACT

A system and method for detecting defects in an object includes illuminating the object with a coherent light, recording the a speckle pattern of the coherent light reflected and/or scattered and/or transmitted from the object, and analyzing the speckle pattern using a trained artificial neural network to determine whether defects are present in the object and the types of defects. To train the neural network, sample objects having known types of defects or no defects are illuminated with a coherent light and the speckle patterns are recorded. The speckle patterns are labeled with the type of defects in the corresponding sample objects, and used as training data to train the network. The technique analyzes the speckle patterns directly, and does not require phase recovery and object shape reconstruction. The technique is useful for defect inspection in industrial production to detect defects such as scratches, air bubbles, deformation, stains, etc.

### BACKGROUND OF THE INVENTION

### Field of the Invention

This invention relates to system and method for defect inspection on object surface or in object interior, and in particular, it relates to a defect detecting system using coherent light illumination on object to generate speckle patterns and using neural networks to analyze the speckle patterns generated by the coherent light illumination.

### Description of Related Art

Machine vision technologies have experienced rapid development in recent years and are now widely used in many technology areas. For example, machine vision is widely used in industrial assembly lines to automatically inspect the exterior of products, which significantly improves the speed of such inspection. Machine vision enables more intelligent and more rapid automation in industries.

During industrial production, surface defects of products are unavoidable. Different types of products may experience different types of surface defects. Typically, surface defects refer to areas on the surfaces of products that have local nonuniformities in physical or chemical properties. For example, surfaces of metal products may have scratches, spots or cavities; surfaces of paper or fabric materials may have discoloration or creases, surfaces of glass and other non-metallic products may have foreign particles, wear, or stain, etc. Other types of surface defects may include bumps, particles, residue, corrosion, geometric and color variations, etc. Surface defects can affect the aesthetics and user impression, as well as the functions of the products. Therefore, detection of surface defects is important in manufacturing, so that such defects in products can be timely discovered to improve product quality, as well as to analyze and solve quality control issues in the production process.

### SUMMARY

The present invention is directed to a surface or interior defect detection apparatus and related method that substantially obviate one or more of the problems due to limitations and disadvantages of the related art.

Embodiments of the present invention provide a system and method for defect inspection which combines coherent light source illumination and neural network to extract information relevant to the defects of the product. This technique can detect the existence of defects on a product and classify the types of defects.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve the above objects, the present invention provides a system for detecting surface or interior defects in a test object, which includes: a coherent light source being positioned to illuminate the test object with the coherent illumination light; a 2D array image sensor, positioned to record a light pattern of the coherent illumination light after the coherent illumination light has interacted with the test object, the light pattern containing a speckle pattern; and a data processing apparatus coupled to the image sensor, the data processing apparatus implementing a trained artificial neural network configured to analyze the speckle pattern to determine whether any defect is present in the test object and a type of the defect present.

In another aspect, the present invention provides a method for detecting defects in a test object, which includes: illuminating the test object with a coherent illumination light; by a two-dimensional image sensor, recording a light pattern of the coherent illumination light after the coherent illumination light has interacted with the test object, the light pattern containing a speckle pattern; and by a data processing apparatus which implements a trained artificial neural network, analyzing the light pattern to determine whether any defect is present in the test object and a type of the defect present.

In another aspect, the present invention provides a method for detecting defects in a test object, which includes: obtaining a plurality of sample objects, each sample object either having no defects or having known types of defects; illuminating each sample object with a coherent illumination light; for each sample object being illuminated, using a two-dimensional image sensor, recording a light pattern of the coherent illumination light after the coherent illumination light has interacted with the sample object, the light pattern containing a speckle pattern, to obtain a plurality of light patterns corresponding to the plurality of sample objects; labeling each light pattern with a label indicating the types of defects or an absence of defects in the corresponding sample object, to generate a plurality of labeled light patterns; obtaining an untrained artificial neural network implemented in a data processing apparatus; training the untrained artificial neural network using the plurality of labeled light patterns as training data, to produce a trained artificial neural network; illuminating the test object with a coherent illumination light; using a two-dimensional image sensor, recording a light pattern of the coherent illumination light after the coherent illumination light has interacted with the test object, the light pattern containing a speckle pattern; and using a data processing apparatus which implements the trained artificial neural network, analyzing the light pattern to determine whether any defect is present in the test object and a type of the defect present.

The types of defects may include scratches, concave or convex deformations, air bubbles, color variation, microscopic unevenness, stains, and chipping.

It is to be understood that both the foregoing general description and the following detailed description are exemplary and explanatory and are intended to provide further explanation of the invention as claimed.

### BRIEF DESCRIPTION OF THE DRAWINGS

FIG. 1 schematically illustrates a conventional optical imaging system for defect detection.

FIGS. 2A-2D schematically illustrate various defect detection systems using coherent illumination light according to embodiments of the present invention.

FIG. 3 schematically illustrates incident coherent light and scattered coherent lights in a defect detection systems according to embodiments of the present invention.

FIG. 4 illustrates examples of speckle patterns generated by illuminating surfaces of metal samples with a coherent light.

FIG. 5 schematically illustrates a method of using a neural network model to classify defects based on speckle patterns.

FIG. 6 schematically illustrates the training process and detection process using a neural network to analyze speckle patterns generated by illuminating objects with coherent light according to embodiments of the present invention.

FIG. 7 schematically illustrates a process of detecting defects using coherent light illumination and a neural network model according to embodiments of the present invention.

### DETAILED DESCRIPTION OF PREFERRED EMBODIMENTS

Conventional technologies for defect inspection involve taking images of the product sample using a camera under incoherent illumination, and performing image processing to extract information of the defects. FIG. 1 schematically illustrates a conventional optical imaging system for surface defect detection. As shown in FIG. 1, the conventional system uses an incoherent light source 101, which often has a complex structure, to illuminate an object 102 being inspected, and uses a camera 103 with high quality (high-resolution, low aberration, large depth of field) imaging optics 104 to image the object surface. In such a system, the angle α of the camera with respect to the illumination light, the distance D11 from the light source to the object surface (illumination distance), the distance D12 from the object surface to the camera optics (object distance), and the angle of the object surface with respect to the object surface are fixed. The image data 106 obtained by the camera 103 is processed by a data processing device 105 (such as a computer, microprocessor, etc.) to detect surface defects.

In a conventional defect detection system such as that shown in FIG. 1, detection of fine defects is often impeded by various factors of the detection system or the objects being inspected, such as: the spectrum of the illumination light source, the angle of the light source with respect to the object, the viewing angle of the camera, the depth of field of the imaging optics of the camera, the spatial resolution of the imaging optics, the spatial resolution of the two-dimensional image sensor of the camera, the variation in the distance between the object and the imaging optics (object distance), the variation in the image distance of the imaging optics, the material and shape of the object, non-uniformity in the object, ambient light, etc. Any change in the above factors can cause significant change in the image itself, as well as the imaging quality of the system, which in turn affect the reliability of the defect detection. One of the most significant factor is that, because the three-dimensional shape of the object varies from object to object, and the orientation of the defects also varies, the illumination system often cannot effectively reveal or highlight the defects. For example, defects on highly reflective surfaces such as glass surfaces, defects on a curved surface, minute raised or recessed features on a wafer surface, etc., cannot be effectively detected using the above conventional detection system. Another problem with the conventional detection system is that, under strong illumination light intensities, due to reflection, the image sensor in the camera can become saturated. In addition, the conventional techniques ignore the spectral information which may be critical for detecting certain types of defects.

While coherent light sources have been used in the semiconductor industry to detect and analyze micrometer scale defects with success, directly applying this technology to other industries where the products and their defects are in much larger scale results in significant noise (for example, due to too many reflections and scattering across a much larger scale) and thus difficulties in surface defect detection.

The defect detection system according to embodiments of the present invention solve the above problems of the conventional technology. One key feature of the system is that it uses a optical detection system that does not rely on obtaining a geometric image of the object in order to detect defects. Speckle patterns produced by the object under coherent light illumination are analyzed to perform pattern recognition using an artificial neural network, to recognize the type of defects present on the object. Using phase retrieval image data processing for object surface image reconstruction is not required. Rather, the speckle patterns are fed directly into the artificial neural network to classify the defects based on characteristics of speckle patterns associated with different types of defects, which has been leaned by the artificial neural network through a training process.

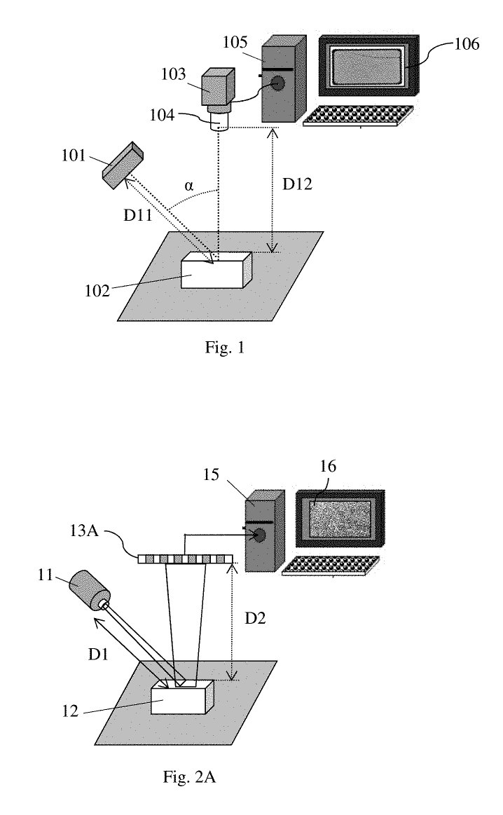

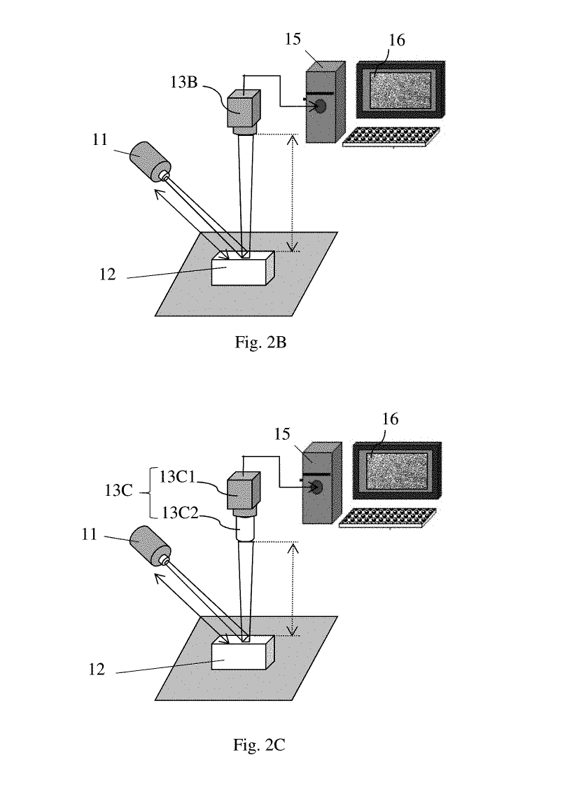

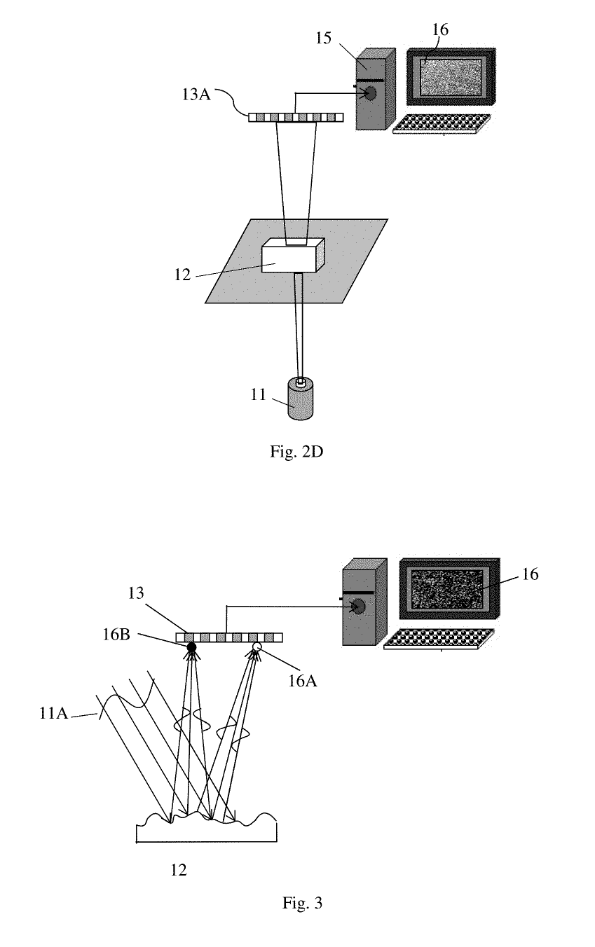

FIG. 2A schematically illustrates a defect detection system according to an embodiment of the present invention. As shown in FIG. 2A, the defect detection system uses a coherent illumination light source 11, such as a laser device, to illuminate the object 12 being inspected. The surface of the object is not required to be planar, and may be curved. After the coherent illumination light interacts with the object 12, e.g., being reflected and/or scattered and/or transmitted by the object, the light pattern of the coherent light is received and recorded by a two-dimensional image sensor 13A, such as a charge-coupled device (CCD) or complementary metal-oxide-semiconductor (CMOS) detector with associated drive and readout circuits. The detected light pattern contains a speckle pattern as will be discussed in more detail later. The light pattern data 16 is processed by a data processing apparatus 15 (such as a computer, microprocessor, GPU (graphics processing unit), cluster of processors, etc.).

FIGS. 2B an 2C schematically illustrate two alternative embodiments of the present invention. The defect detection systems in FIGS. 2A-2C are similar except for the following. In the embodiment of FIG. 2A, the image sensor 13A is a two-dimensional detector used directly without any imaging optics. In the embodiment of FIG. 2B, the image sensor 13B is a camera without additional imaging optics. In the embodiment of FIG. 2C, the image sensor 13C includes a camera 13C1 with additional imaging optics 13C2 in front. In the embodiments of FIGS. 2A and 2B, the angle and the distance D2 of the image sensor 13A/13B relative to the object 12 are adjustable, whereas in the embodiment of FIG. 2C, the distance of the image sensor 13C relative to the object 12 are not adjustable. This is because when imaging optics are used, the object distance (the distance from the object to the optics) is constrained by the working distance range of the imaging optics. In all three embodiments, the distance D1 between the illumination light source and the object may be adjustable. In some alternative embodiments, one or more of the illumination source 11, the object 12, and the image sensor 13A/B/C are mounted on appropriate support structure (not shown) that allow their positions and/or orientations to be adjusted. The two-dimensional image sensor 13A/B/C may have a flat or curved detection surface.

In the exemplary configurations shown in FIG. 2A-2C, the two-dimensional image sensors 13A-13C detect reflected and/or scattered illumination light from the object 12. Such light may be generated by light reflection and/or scattering from the surface of non-transparent objects, subsurface scattering by translucent objects, and light reflection and/or scattering by interior structures of transparent or semi-transparent objects. Thus, these systems can be used to detect defects on the surface, sub-surface and interior defects of various types of objects. Examples of non-transparent materials include metal, certain plastics, etc. Examples of translucent materials include marble, wax, certain ceramics, certain plastics, etc. Examples of transparent and semi-transparent materials include glass, certain plastics, etc.

In an alternative system shown in FIG. 2D, which can be used to detect defects in the interior of transparent or semi-transparent objects, the illumination light source 11 and the two-dimensional image sensor 13A are disposed on different sides of the object, and the image sensor detects and records illumination light from the light source that has transmitted through the object and has been scattered by interior structures (e.g. defects) of the object. While some of the descriptions below use surface defects as examples, the same principles and methods can be used to detect subsurface or interior defects of translucent, transparent or semi-transparent objects.

The speckle pattern in the light pattern data 16 detected by the image sensor 13A/B/C contains information about the microscopic structures or defects on the object's surface or in the object's interior (for example, when the object transmits light), such as scratches, chipping, air pockets, concave or convex deformations, etc. The speckle pattern is analyzed by the data processing device 15 to perform pattern recognizing using an artificial neural network, to recognize the type of defects present on the object. As discussed earlier, phase recovery and object shape reconstruction from the speckle pattern are not required. Rather, the speckle patterns are fed directly into the artificial neural network to classify the defects based on characteristics of speckle patterns associated with different types of defects, which has been leaned by the artificial neural network through a training process.

This defect detection system solves the above-discussed problems of the conventional defect detection system, as it does not impose rigid requirements on the object distance, the position and viewing angle of the camera, or the distance from the illumination source to the object. This also makes the detection system simple and easy to use.

A coherent light is a light in which, at any given point in space or time, and particularly within an area on a plane perpendicular to the light propagation direction, or at any time point for a given point in space, the parameters of the light are predictable and related. In a coherent light, different points of the light wave have known phase relationships. A laser can generate highly coherent light. Two light beams that are coherent with each other can interfere with each other and produce interference patterns.

When a rough surface is illuminated by a coherent light, the light scattered by different points of the surface are coherent with each other but have different amplitudes and phases, and their directions are distributed in space. Such light beams interfere with each other, where the waves are added together so that the amplitude is greater in some places and lesser in other places, as schematically illustrated in FIG. 3 which shows the incident coherent light 11A and scattered coherent lights. As a result, the reflected light have a grainy structure with relatively high contrast between the brighter and darker areas. The grains are commonly referred to as speckles, and the reflected light pattern is commonly referred to as speckle patterns. At the scale of the wavelength of the illumination light, most surfaces are rough, so their reflected light form speckle patterns due to light interference. Thus, speckle patterns are a result of coherent light illumination. The characteristics of each speckle pattern are determined by the surface characteristics of the object and the coherency of the illumination light. For example, the contrast in the speckle pattern is closely related to the surface roughness of the object.

The characteristic sizes of speckles in a speckle pattern is determined by not only the location of the observation plane, but also the wavelength of the illumination light. When the observation position is in the near field, then the average speckle size in directions perpendicular to the light propagation direction is

$$Δ {x}_{s} \approx \frac{λ}{α} = λ \frac{L}{d} \qquad ( 1.1 )$$

and the average speckle size the directions parallel to the light propagation direction is

$$Δ {z}_{s} \approx \frac{λ}{{α}^{2}} = {λ ( \frac{L}{d} )}^{2} \qquad ( 1.2 )$$

where λ is the wavelength of the illumination light, α is the angle spanned by the illuminated scattering surface with respect to the observation position, d is the linear dimension (e.g. diameter) of the scattering surface, and L is the distance from the scattering surface to the position of observation.

When the observation position is in the far field, e.g., the speckle pattern is observed behind a focusing lens at the focal plane of the lens, then the average speckle size is

$$Δ {x}_{s} \approx \frac{λ}{α} = λ \frac{{f}^{′}}{D} \qquad ( 1.3 )$$

where f′ is the focal distance of the lens and the D is the diameter of the lens.

When the observation plane is not on the focal plane of the lens, then the magnification of the lens needs to be considered, and the average speckle size is

$$Δ {x}_{s} \approx \frac{λ}{α} = λ \frac{{z}^{′}}{D} \qquad ( 1.4 )$$

where z′ is the image distance.

From the above equations, it can be seen that for the same object, the longer the illumination light wavelength, the larger the speckles. The size and contrast of the speckles are also closely related to the degree of coherence of the illumination light; the higher the degree of coherence, the larger the speckle size and the higher the contrast. The coherence length of a light is related to the degree of coherence of the light and may be used as an indication of degree of coherence. Of course, wavelength and the degree of coherence are not the only factors that affect the speckle size.

It should be noted that when the instant disclosure refers to “coherent illumination light”, the term encompasses light of different degrees of coherence. In other words, the term “coherent illumination light” as used in this disclosure broadly encompasses light that may be deemed “partial coherent light.” In practice, the degree of coherence of the coherent illumination light is a parameter of the defect detection system that may be adjusted to optimize the defect detection accuracy. Preferably, the coherent illumination light having the same or similar degrees of coherence are used to illuminate the objects during acquisition of training data and during test object inspection.

Moreover, in practice, ambient incoherent light may be present and be recorded by the image sensor of the defect detection system. A certain amount of ambient incoherent light may be tolerated without significantly affect the defect detection accuracy of the system.

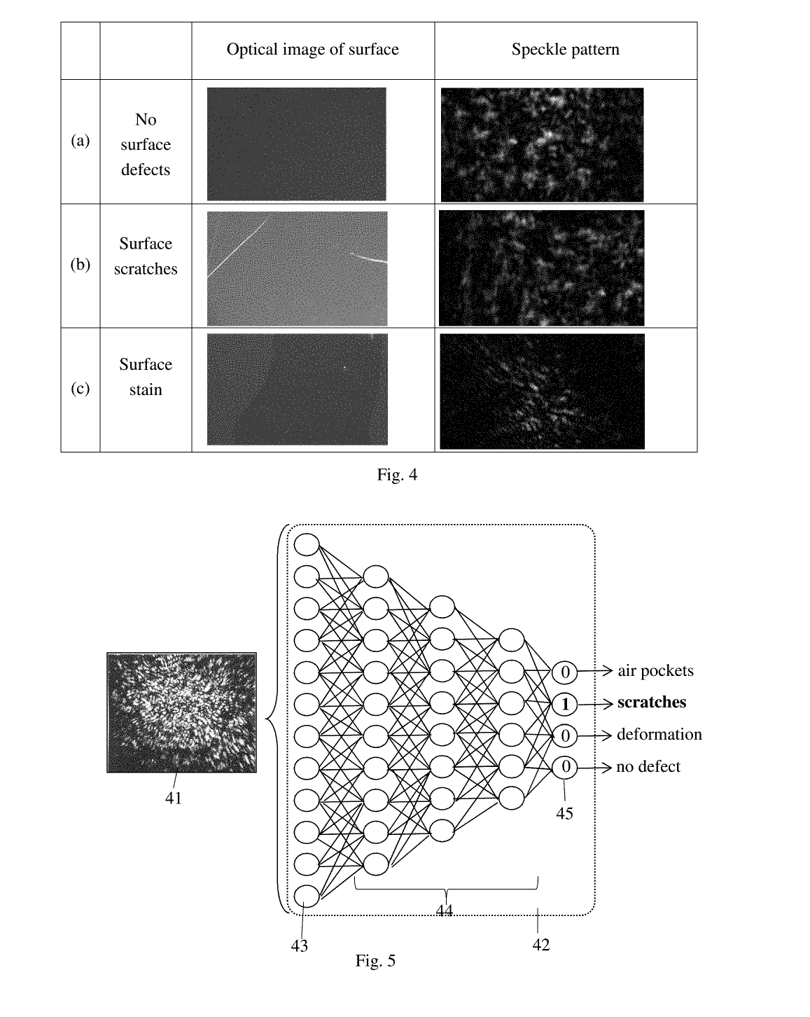

FIG. 4 illustrates a few examples of speckle patterns generated by illuminating surfaces of metal samples with a coherent light. Panel (a) shows the optical image of a metal surface without defects and the corresponding speckle pattern generated by the surface under coherent light illumination. Panel (b) shows the optical image and speckle pattern of a metal surface with scratches. Panel (c) shows the optical image and speckle pattern of a metal surface with oil stain. Note that the speckle patterns in these examples were not taken from actual samples, but are merely intended to explain the phenomenon that speckle patterns from different types of defects have different characteristics. The characteristics of speckle patterns and their relationship with the types of defects may not be obvious to human observers, but computer-implemented pattern recognition algorithms, such as one implemented in artificial neural network models, can recognize such characteristics and determine the corresponding types of defects.

Thus, by illuminating an object with a coherent light source, detecting the speckle pattern generated by the reflected and/or scattered and/or transmitted light from the object, and then analyzing the speckle patterns using artificial neural network based machine learning methods, defect detection and classification can be achieved. The neural network model can be trained using a large training dataset that contains speckle patterns label with the corresponding defect classification.

Artificial neural networks are used in various fields such as machine leaning, and can perform a wide range of tasks such as computer vision, speech recognition, etc. An artificial neural network is formed of interconnected layers of nodes (neurons), where each neuron has an activation function which converts the weighted input from other neurons connected with it into its output (activation). In a training process, training data are fed into to the artificial neural network and the adaptive weights of the interconnections are updated through the training process. After training, data can be inputted to the trained network to generate results (referred to as prediction). Advantages of neural networks include parallel processing, error tolerance, hardware implementation, and the learning ability.

One type of neural network is convolutional neural network (CNN), which is a type of feed-forward artificial neural networks. CNNs are useful particularly in image recognition. Inspired by the structure of the animal visual cortex, a characteristic of CNNs is that each neuron in a convolutional layer is only connected to a relatively small number of neurons of the previous layer. A CNN typically includes one or more convolutional layers, pooling layers, ReLU (Rectified Linear Unit) layers, fully connected layers, and loss layers. In a convolutional layer, the core building block of CNNs, each neuron computes a dot product of a 3D filter (also referred to as kernel) with a small region of neurons of the previous layer (referred to as the receptive field); in other words, the filter is convolved across the previous layer to generate an activation map. This contributes to the translational invariance of CNNs. In addition to a height and a width, each convolutional layer has a depth, corresponding to the number of filters in the layer, each filter producing an activation map (referred to as a slice of the convolutional layer). A pooling layer performs pooling, a form of down-sampling, by pooling a group of neurons of the previous layer into one neuron of the pooling layer. A widely used pooling method is max pooling, i.e. taking the maximum value of each input group of neurons as the pooled value; another pooling method is average pooling, i.e. taking the average of each input group of neurons as the pooled value. The general characteristics, architecture, configuration, training methods, etc. of CNNs are well described in the literature. Various specific CNNs models have been described in literatures.

Neural networks and the training and prediction processes may be implemented on computers including specialized processors or processor clusters. The computers include memories storing computer executable program instructions.

FIG. 5 schematically illustrates a method of using a neural network model to classify defects based on speckle patterns. A speckle pattern 41 is inputted into a neural network model 42. For example, the input speckle pattern 41 may be one generated by a surface having scratch defects. The neural network model includes a layer of input neurons 43, multiple intermediate layers of neurons 44, and an output layer of neurons 45. The output layer 45 is a classifier and outputs a vector, where each value of the vector represents the probability of the input pattern belonging to one of the predefined classes, such as air pockets, scratches, deformation, stains, etc. The class with the highest probability is deemed to be the defect type present in the sample object. Note that the neural network 42 in FIG. 5 is only intended to be a schematic illustration and does not represent the actual number of layers, etc. of the neural network.

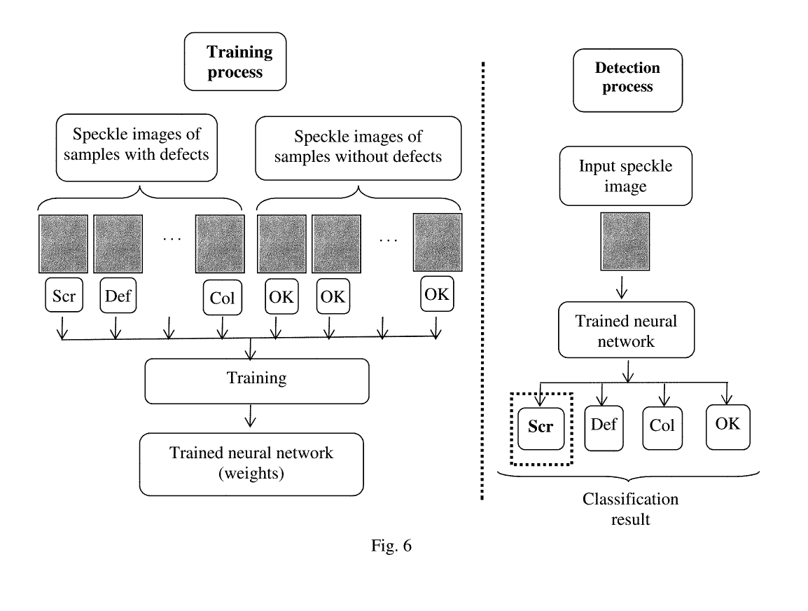

FIG. 6 schematically illustrates the training process and the detection process using the neural network. In the training process, a large amount of training data, i.e. speckle patterns each labeled with the correct type of defect (all different types of defects that the system is designed to detect should be included in the training data), is inputted into an untrained neural network and an iterative training process is conducted to obtain the weights of the network. In the detection process, each speckle pattern to be processed is inputted into the trained neural network, and the network outputs a classification result which represent probabilities of each type of defect being present in the input speckle pattern.

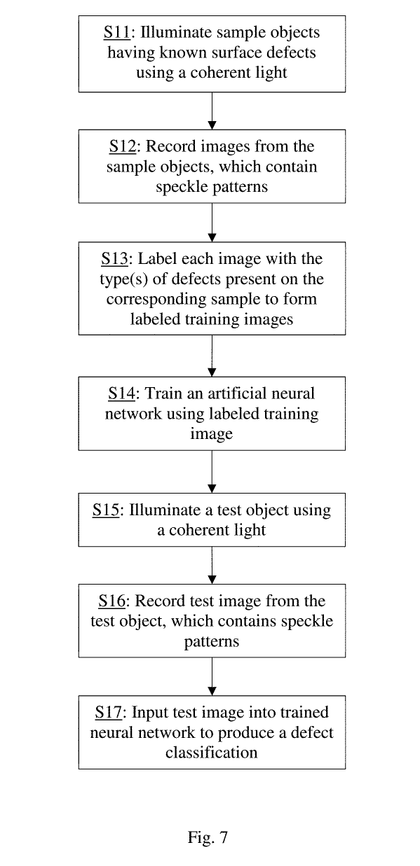

FIG. 7 is a flow chart that schematically illustrates a process of detecting defects in objects using coherent light illumination and a neural network model according to an embodiment of the present invention. Sample objects with known defect types are illuminated using a coherent light (step S11) and the light patterns from the sample objects (speckle patterns) are recorded (step S12). Steps S11 and S12 may be performed using the systems shown in FIGS. 2A-2C or variations thereof. As noted earlier, all different types of defects the system is designed to detect should be represented in the sample objects. Each of these speckle patterns is labeled with the type(s) of defects present on the corresponding sample object (step S13). An untrained neural network model is obtained, and trained using the labeled speckle patterns as training data (step S14). Any suitable neural network model and training method may be used, for example, a network based on a convolutional neural network. The training step S14 produces a trained neural network.

To detect defects in an object (test object), the test object is illuminated using a coherent light (step S15) and a speckle patterns (test pattern) from the test object is recorded (step S16). Steps S15 and S16 may be performed using the systems shown in FIGS. 2A-2C. As explained earlier, the method does not have rigid requirements on the object distance, the position and viewing angle of the camera, the distance from the illumination source to the object, or the surface shape, so the placement of the test object in steps S15 and S16 may vary from the placement of the sample objects in steps S11 and S12. The test pattern is inputted into the trained neural network, which outputs a defect classification (step S17).

In practice, to achieve more accurate defect detection results, the training data is preferably obtained from sample objects that are generally similar in nature (e.g., similar in material or type of material, approximate size, overall shape, etc.) as the test objects. In practical applications such as manufacturing, for example, the sample objects used to generate training data and the test objects may be the same product or same kinds of products, for example: both are back covers of mobile phones made of plastic, both are front glass covers of mobile phones, etc.

As mentioned above, the defect detection method may be used to detect scratches, protrusions (convex deformations), indentations (concave deformations), air bubbles, color variation, microscopic unevenness, etc. in objects. The defect detection method described above may also be used to detect Mura defects of a thin film transistor (TFT) liquid crystal display (LCD) modules. Such a display module uses TFTs to control alignment angles of liquid crystals. The light from light source passes through liquid crystals of different alignment angles, and then pass through a color filter (CF), to display different colors. Mura defects occur in LCD panels due to uneven patches of changes in luminance. The above-described defect detection method may be used to detect Mura defects in LCD.

Sometimes, an object may contain two or more different types of defects. To detect the simultaneous presence of different types of defects in samples, labeled training data from objects containing two or more types of defects are used for training (each training pattern is labeled with all defect types present in that object). The training data includes speckle patterns corresponding to all combinations of different types of defects that the system is designed to detect. When analyzing the speckle patterns of an object being inspected, the classification output is a vector where each value represents the probability of the input pattern belonging to one of the predefined classes, such as air pockets, scratches, deformation, stains, etc. The one or more classes with a probability much higher than the other classes are deemed to represent the type(s) of defect present in the sample.

In one alternative embodiment, the neural network model may be continuously trained using the classification result of test patterns generated in step S17. For example, classification results generated by the neural network model may be examined by a human inspector to correct any inaccurate classification, and these speckle patterns with the corrected classification may be used to construct additional training data to further train the network model.

In another alternative embodiment, two or more neural network models may be used, where some of the network models may include certain empirical knowledge. The multiple network models may be combined to produce more accurate classification results. For example, the classification generated by the multiple network models may be assigned respective weights, and the final classification is a weighted sum of the classification of different network models. The weights may be predefined, or may be adjusted during the training process.

Advantages of the above defect detection system and method include the following: It uses a non-imaging method, which refers to the fact that the recorded light pattern (speckle pattern) is not a geometric image of the object. It uses a coherent illumination light source. The characteristics of the defects are contained in the speckle patterns, which does not require a high-precision optical imaging system to detect. The detection method is not affected by the surface shape or deformation of the object, and is not constrained by the requirement of a fixed object distance. Thus, a simple and efficient detection system may be employed, making the method suitable for defect detection for industrial products, consumer products, etc. The system may be used to detect defects on highly reflective surfaces such as glass surfaces, on a curved surface, etc. that cannot be well detected using conventional methods.

It will be apparent to those skilled in the art that various modification and variations can be made in the defect detection system and method of the present invention without departing from the spirit or scope of the invention. Thus, it is intended that the present invention cover modifications and variations that come within the scope of the appended claims and their equivalents.

What is claimed is:

1. A system for detecting defects in a test object, comprising:
a coherent light source generating a coherent illumination light, the coherent light source being positioned to illuminate the test object with the coherent illumination light;
a two-dimensional image sensor, positioned to record a light pattern of the coherent illumination light after the coherent illumination light has interacted with the test object, the light pattern containing a speckle pattern; and
a data processing apparatus coupled to the image sensor, the data processing apparatus implementing a trained artificial neural network configured to analyze the light pattern to determine whether any defect is present in the test object and at least one type of the defect that is present.

2. The system of claim 1, wherein the artificial neural network has been trained to determine whether one or more types of defects selected from the following group are present in the test object: scratches, concave or convex deformations, air bubbles, color variation, microscopic unevenness, stains, and chipping.

3. The system of claim 1, wherein the trained artificial neural network is configured to analyze the light pattern to determine presence and types of defects in the test object without performing phase recovery or object shape reconstruction.

4. The system of claim 1, wherein the image sensor is positioned to record a light pattern of the coherent illumination light that has been reflected and/or scattered by the test object.

5. The system of claim 1, wherein the image sensor is positioned to record a light pattern of the coherent illumination light that has transmitted through the test object and has been scattered by interior structures of the test object.

6. The system of claim 1, wherein the two-dimensional image sensor is a charge-coupled device (CCD) or complementary metal-oxide-semiconductor (CMOS) detector without imaging optics.

7. The system of claim 1, wherein the two-dimensional image sensor is a camera.

8. The system of claim 1, wherein the two-dimensional image sensor includes a camera and imaging optics.

9. A method for detecting defects in a test object, comprising:
illuminating the test object with a coherent illumination light;
by a two-dimensional image sensor, recording a light pattern of the coherent illumination light after the coherent illumination light has interacted with the test object, the light pattern containing a speckle pattern; and
by a data processing apparatus which implements a trained artificial neural network, analyzing the light pattern to determine whether any defect is present in the test object and at least one type of the defect that is present.

10. The method of claim 9, wherein the artificial neural network has been trained to determine whether one or more types of defects selected from the following group are present in the test object: scratches, concave or convex deformations, air bubbles, color variation, microscopic unevenness, stains, and chipping.

11. The method of claim 9, wherein the analyzing step is performed without performing phase recovery or object shape reconstruction.

12. The method of claim 9, wherein the recording step includes recording a light pattern of the coherent illumination light that has been reflected and/or scattered by the test object.

13. The method of claim 9, wherein the recording step includes recording a light pattern of the coherent illumination light that has transmitted through the test object and has been scattered by interior structures of the test object.

14. A method for detecting defects in a test object, comprising:
obtaining a plurality of sample objects, each sample object either having no defects or having known types of defects;
illuminating each sample object with a coherent illumination light;
for each sample object being illuminated, using a two-dimensional image sensor, recording a light pattern of the coherent illumination light after the coherent illumination light has interacted with the sample object, the light pattern containing a speckle pattern, to obtain a plurality of light patterns corresponding to the plurality of sample objects;
labeling each light pattern with at least one label indicating the type of types of defects or an absence of defects in the corresponding sample object, to generate a plurality of labeled light patterns;
obtaining an untrained artificial neural network implemented in a data processing apparatus;
training the untrained artificial neural network using the plurality of labeled light patterns as training data, to produce a trained artificial neural network;
illuminating the test object with a coherent illumination light;
using a two-dimensional image sensor, recording a light pattern of the coherent illumination light after the coherent illumination light has interacted with the test object, the light pattern containing a speckle pattern; and
using a data processing apparatus which implements the trained artificial neural network, analyzing the light pattern to determine whether any defect is present in the test object and at least one type of the defect that is present.

15. The method of claim 14, wherein the plurality of sample objects include a plurality of sample objects having no defects and a plurality of sample objects each having one or more defects selected from the following group: scratches, concave or convex deformations, air bubbles, color variation, microscopic unevenness, stains, and chipping.

16. The method of claim 14, wherein the analyzing step is performed without performing phase recovery or object shape reconstruction.

17. The method of claim 14, wherein the recording step records a light pattern of the coherent illumination light that has been reflected and/or scattered by the test object.

18. The method of claim 14, wherein the recording step records a light pattern of the coherent illumination light that has transmitted through the test object and has been scattered by interior structures of the test object.
